(19) United States
(12) Patent Application Publication
(10) Pub. No.: US 2022/0395003 A1
(43) Pub. Date: Dec. 15, 2022

(54) Methods for Use in Food Processing and Preservation

(71) Applicants: Stanley Weller, Marietta, GA (US); Lloyd Starks, Spring City, TN (US); Shecoya White, West Point, MS (US); Derris Burnett, West Point, MS (US)

(72) Inventors: Stanley Weller, Marietta, GA (US); Lloyd Starks, Spring City, TN (US); Shecoya White, West Point, MS (US); Derris Burnett, West Point, MS (US)

(21) Appl. No.: 17/892,768

(22) Filed: Aug. 22, 2022

Related U.S. Application Data
(62) Division of application No. 16/792,065, filed on Feb. 14, 2020, now abandoned.
(60) Provisional application No. 62/805,421, filed on Feb. 14, 2019.

(51) Int. Cl. A23L 3/3562; A23L 3/358; A23L 3/3508; A23B 4/20; A23B 4/24; A23B 7/157; A01N 25/10; A01N 37/02; A01N 59/02; A23B 7/154

(52) U.S. Cl. CPC A23L 3/3562; A23L 3/358; A23L 3/3508; A23B 4/20; A23B 4/24; A23B 7/157; A01N 25/10; A01N 37/02; A01N 59/02; A23B 7/154; A23V 2002/00

(57) ABSTRACT

The disclosure includes novel food coatings and methods of preserving foods and of protecting against damage and/or spoilage to improve appearance, shelf life, and marketability of the foods. The food coatings involve a chitosan solution including chitosan, an organic acid, and a sulfite salt. The food coatings are edible and may create a film on food that protects the food from discoloration, mold growth, and spoilage. The chitosan solution may be applied by spraying, immersion, wiping, fogging, etc. The chitosan solution is show to extend shelf-life of at least catfish, beef steak, hamburger, fruit, vegetables, and berries.

### CROSS-REFERENCE TO RELATED APPLICATIONS

This patent application is a divisional of U.S. Provisional patent application Ser. No. 16/792,065, filed Feb. 14, 2020 by Stanley Weller, et. al., and titled “Compositions and Methods for Use in Food Processing and Preservation,” which claims the benefit of U.S. Provisional Patent Application No. 62/805,421, filed Feb. 14, 2019 by Stanley Weller, et. al., which are hereby incorporated by reference in their entirety.

### TECHNICAL FIELD

This disclosure relates generally to the field of food coatings and, more particularly, to food coatings, compositions, and products and methods to process and preserve foods and to protect against mold, rot, and/or spoilage and to improve appearance, shelf life, and marketability.

### BACKGROUND

It is generally known to coat food products, such as meats, fruits, vegetables, and nuts, for example, to protect them against mold, rot, spoilage, and water damage and to improve their appearance and, hence, their marketability. Common coatings now in use employ proteins, gums, resins, hydrocolloids, waxes, and oils either alone or in combination, to achieve certain desired objectives. Enhancing appearance, slowing moisture loss, and affecting the respiration or ripening process of fruits, nuts, and vegetables, are several goals of many modern food coatings.

U.S. Pat. No. 5,633,025 discloses a bioactive coating for fruits, vegetables, and nuts, comprising modified chitosan and at least one antagonistic yeast effective for the biocontrol of postharvest diseases and glucose, wherein the modified chitosan is glycolchitosan or carboxymethylchitosan. U.S. Pat. No. 6,423,310 discloses a biological coating for plants comprising chitosan salts, an antagonistic yeast, and CaCl2. The durability of these coatings may be insufficient. U.S. Pat. No. 7,771,763 suggests an improved coating for fruits, nuts, and vegetables comprising an additive such as a carnauba wax emulsion, sodium benzoate and zinc acetate and a chitosan polymer, the coating having a solids content greater than 5% and a liquid viscosity when applied to the outer surface of the food product.

Chitosan is not generally considered useful for coating meat, such as beef, chicken, lamb, pork, fish, and the like. U.S. Pat. No. 4,871,556 discloses applying N-carboxymethyl-chitosan to meat by spraying as a powder or aqueous solution to prevent the occurrence of “warmed over flavor”. There is no evidence that N-carboxymethyl-chitosan preserves meat when applied topically to meat. In addition, there is no evidence that unmodified chitosan can be used to preserve meat and prevent its discoloration.

As a result, a simple formulation of chitosan and method of application is needed that will form a coating or film on food, such as on the surface of meats, fruits, and vegetables, for example, to preserve the meats, fruits, and vegetables and to prevent discoloration and premature spoilage. The present disclosure provides such coatings, compositions, products. and methods.

### SUMMARY

The present disclosure provides novel coatings, compositions, and products and methods for preserving foods. The disclosure provides food coatings, compositions, and products and methods for protecting against damage and spoilage, such as mold and rot, and for retaining and/or improving appearance to enhance shelf life and marketability.

With the foregoing and other objects, features, and advantages of the disclosure that will become apparent hereinafter, the nature of the disclosure may be more clearly understood by reference to the detailed description, figures, preferred embodiments, and appended claims.

### BRIEF DESCRIPTION OF THE DRAWINGS

The figures shown in the Detailed Description are intended to illustrate further the disclosure and its advantages. The figures, which are incorporated in and form a portion of the specification, illustrate certain preferred embodiments of the disclosure and, together with the entire specification, are meant to explain preferred embodiments of the present disclosure to those skilled in the art. Relevant FIGURES in this Application are shown or described in the Detailed Description of the disclosure, as follows:

FIG. 1 shows a photograph obtained by scanning electron microscopy of chitosan coatings formed on silicon wafers when chitosan solutions of the present disclosure are applied by placing a drop of chitosan solution on the surface of the wafer.

FIG. 2 shows a photograph obtained by scanning electron microscopy of chitosan coatings formed on silicon wafers when chitosan solutions of the present disclosure are applied by a dry steam generator using the chitosan solution of the disclosure as the liquid source.

FIG. 3 shows a graphical representation of the effect of the chitosan application of the present disclosure on the shelf-life extension of refrigerated catfish stored at about 4° C.

### DETAILED DESCRIPTION

The disclosure provides novel food coatings, compositions, membranes, and products and methods to process and/or preserve foods and to protect against mold, rot, and/or spoilage and to improve appearance, shelf life, and marketability. The compositions comprise chitosan, sulfite, and acid. The disclosure includes methods of forming an antimicrobial coating and/or membrane compositions and applying or forming such coating in and/or on food and food surfaces in processing and protecting the foods.

A combination of low, medium, and high molecular weight chitosan, 65-99% deacetylated chitosan, was purchased from HeiQ Chemtex, Concord, N.C. These were contained or dissolved in an aqueous solution with 0.05%-5.0% low molecular weight organic acid, such as lactic, citric, acetic, or a combination thereof, for example, preferably acetic acid, and 0.005%-5.0% soluble sulfite salt, such as potassium sulfite, ammonium sulfite, sodium sulfite, or a combination thereof, for example, preferably sodium sulfite salt. Molecular weight is defined based on the viscosity of 6% chitosan in water. Low molecular weight chitosan has less than 25 centipoise viscosity. Medium molecular weight has less than 100 centipoise viscosity and greater than 25 centipoise viscosity. High molecular weight chitosan has less than 500 centipoise viscosity and greater than 100 centipoise viscosity. For the 6% solution purchased, the composition was 6% chitosan with a range of about 0.05%-2% acetic acid with a range of about 0.05%-5%; and 0.2% sulfite salt with a range of about 0.005%-5%. The treatment solution utilizes about a 20-fold dilution of the 6% chitosan, which yields a 0.3% chitosan solution. This produces a use composition solution of 0.3% chitosan with a range of 0.05%-0.6%; acetic acid of 0.1% with a range of 0.0025-0.25%; and sulfite salt of 0.01% with a range of 0.00025%-0.25%.

The chitosan solution of the present example is about 0.05% to 12% chitosan by weight in water, preferably 0.3% chitosan by weight in water. The chitosan is a mixture of low, medium, and high molecular weight chitosan. The amount of low molecular weight chitosan is up to about 60% to 99% by weight, preferably up to about 90% by weight. The amount of medium molecular weight chitosan is up to about 1% to 25% by weight, preferably up to about 5% by weight. The amount of high molecular weight chitosan is up to about 1% to 20% by weight, preferably up to about 10% by weight. For example, a 6% solution of 6 grams of the chitosan mixture in 100 ml of water would comprise 3.6 to 5.9 grams of low molecular weight chitosan, 0.06 to 1.5 grams of medium molecular weight chitosan, and 0.06 to 1.2 grams of high molecular weight chitosan. This solution of chitosan is diluted 19 to 21-fold, preferably 20-fold, to produce a 0.05% to 0.6% solution of chitosan by weight, preferably a 0.3% solution of chitosan by weight.

The chitosan is, preferably, dissolved in acidic solutions of organic acids such as any low molecular weight organic acid, i.e., food grade acid, such as acetic, lactic, or citric acid, in the range of 0.05%-5.0% by weight, preferably 2% acetic acid. Acid is added to get the composition soluble. Sodium sulfite salt is added to the diluted chitosan solution in the amount of 0.005% to 5.0% by weight, preferably 0.2% by weight. It was observed in preliminary studies that the chitosan solutions of 0.3% by weight was the most effective concentration for preservation of meats, vegetables, and fruits. In addition, the combination of low, medium, and high molecular weight chitosan also was seen to provide the best preservation of meats, vegetables, and fruits. The inclusion of sodium sulfite in the chitosan solution surprisingly further protected the meats, vegetables, and fruits from discoloration and provided the most uniform chitosan membrane. The protective film formed on the surface of meat and fruit with the 0.3% chitosan solution showed the most uniform and smooth structure. As used herein, “food” is defined as meats, vegetables, and fruits, for example, or a combination thereof. Also as used herein, “meat” includes any edible tissue from any mammal, bird, reptile, amphibian, fish, crustacean, or mollusk.

### Example 1

A 0.3% aqueous solution of chitosan formed as described above having 0.01% sodium sulfite and 0.1% acetic acid was poured into a commercial dry vapor steam cleaning unit and allowed to equilibrate for about 15 minutes. The steam was applied to a beef carcass by the method of Starks as disclosed in U.S. Pat. No. 9,149,036 which is incorporated herein by reference in its entirety. For comparison, a beef carcass was sprayed with an aqueous solution of about 3% acetic acid by standard methods known in the art. Prior to applying the chitosan steam or the aqueous acetic acid solution, the beef carcasses were washed thoroughly with hot water. The beef carcasses were maintained at 4 degrees centigrade. Microbiological analysis was performed on the surface of the carcasses at pretreatment and at 1, 24, and 72 hours after treatment. Results of the effects of the treatments on microbial growth are shown in Table 1 and are expressed as log colony forming units (1×10X). The results show that the steam-applied chitosan solution was not different from the acetic acid solution in suppressing microbiologic growth on the surface of beef and indicate that the chitosan mixture of the present example is a suitable substitute for the acetic acid solution when applied by steam.

TABLE 1

| Carcass | | | | | |
|---|---|---|---|---|---|
| Surface | Treatment | 0 h | 1 h | 24 h | 72 h |
| Loin | Water wash + | 3.70 | 2.40 | 1.80 | 2.00 |
| | acetic acid | | | | |
| | Water wash + | 3.50 | 2.90 | 2.40 | 2.20 |
| | chitosan | | | | |
| | Difference | −0.20 | +0.50 | +0.60 | +0.20 |
| Flank | Water wash + | 2.60 | 2.10 | 2.10 | 2.00 |
| | acetic acid | | | | |
| | Water wash + | 2.50 | 2.50 | 1.70 | 2.00 |
| | chitosan | | | | |
| | Difference | −0.10 | +0.40 | −0.40 | 0.00 |

### Example 2

The study in Example 1 was repeated, applying the previously-described 0.3% chitosan, acetic acid, and sodium sulfite solution on a low surface area and a high surface area of a beef carcass. Results of the effects of the treatments on microbial growth are shown in Table 2 and are expressed as log colony forming units (1×10X). The results show that the chitosan solution was not different from the acetic acid solution in suppressing microbiologic growth on the surface of beef and indicate that the chitosan mixture of the present example is a suitable substitute for the acetic acid solution when applied by steam.

TABLE 2

| Carcass | | | | |
|---|---|---|---|---|
| Surface | Treatment | 1 h | 48 h | 168 h |
| Low | Water wash + | 1.53 | 1.09 | 0.00 |
| (A) | acetic acid | | | |
| | Water wash + | 1.56 | 1.70 | 1.55 |
| | chitosan | | | |
| | Difference | +0.03 | +0.61 | +1.55 |
| Low | Water wash + | 1.73 | 1.57 | 1.45 |
| (B) | acetic acid | | | |
| | Water wash + | 1.37 | 1.11 | 1.35 |
| | chitosan | | | |
| | Difference | −0.36 | −0.46 | −0.10 |
| Low | Water wash + | 0.43 | 0.94 | 1.35 |
| (C) | acetic acid | | | |
| | Water wash + | 1.56 | 1.60 | — |
| | chitosan | | | |
| | Difference | +1.13 | +0.66 | — |
| High | Water wash + | 1.59 | 1.35 | 1.49 |
| (A) | acetic acid | | | |
| | Water wash + | 1.30 | 1.14 | 0.70 |
| | chitosan | | | |
| | Difference | −0.29 | −0.21 | −0.79 |
| High | Water wash + | 2.03 | 1.80 | 1.77 |
| (B) | acetic acid | | | |
| | Water wash + | 0.98 | 1.39 | 0.88 |
| | chitosan | | | |
| | Difference | −1.05 | −0.59 | −0.89 |
| High | Water wash + | 1.88 | 1.65 | 1.43 |
| (C) | acetic acid | | | |
| | Water wash + | 2.29 | 1.86 | 1.76 |
| | chitosan | | | |
| | Difference | +0.41 | +0.21 | +0.33 |

### Example 3

A 0.3% aqueous solution of chitosan of the previously-described 0.3% chitosan, acetic acid, and sodium sulfite solution having 0.01% sodium sulfite and 0.1% acetic acid was mixed with hamburger obtained from grass fed beef. Thirty (30) gram samples of hamburger were mixed with 0.5, 1, 1.5, 2, or 3 ml of the chitosan solution to provide 1.67, 3.3, 5, 6.7, or 10% mixture of hamburger with chitosan solution. A control sample of 30 grams of hamburger was untreated. The hamburger was maintained at 4 degrees centigrade. The hamburger was tested for microbial growth by swabbing a petri dish with the hamburger at pretreatment and at days 4, 8, and 12 after mixing the chitosan solution with the hamburger. Results of the effects of the addition of chitosan to hamburger on microbial growth are shown in Table 3 and are expressed as log colony forming units per gram of hamburger (1×10X/gram). All amounts of chitosan solution added to the hamburger decreased background microbial growth compared to control. Control hamburger became discolored (turning dark) over the 12-day period but chitosan treated hamburger did not become discolored. The actual colony counts were not as beneficial as the physical appearance of the food substrates.

TABLE 3

| Treatment | Day 0 | Day 4 | Day 8 | Day 12 |
|---|---|---|---|---|
| Control | 4.70 | 6.17 | 5.60 | 5.30 |
| Chitosan 1.67% | 4.70 | 5.98 | 5.30 | 5.00 |
| Chitosan 3.3% | 4.70 | 5.94 | 5.76 | 4.30 |
| Chitosan 5% | 4.70 | 5.79 | 5.30 | 4.78 |
| Chitosan 6.7% | 4.70 | 5.15 | 5.28 | 4.30 |
| Chitosan 10% | 4.70 | 5.18 | 4.30 | 4.78 |

### Example 4

A sample of post-dated (expired) beef steak was dipped (immersed) in the previously-described 0.3% chitosan, acetic acid, and sodium sulfite solution, i.e., a 0.3% aqueous solution of chitosan formed as described above having 0.01% sodium sulfite and 0.1% acetic acid. A control post-dated beef steak was untreated. The steaks were maintained at 4 degrees centigrade for 7 days and then examined for appearance. The control steak had a clearly noticeable dark color compared to the chitosan treated steak. The chitosan treated (dipped) steak was noticeably different compared to the control steak after one week of refrigeration, in that the dipped steak showed no signs of brown color while the control steak showed noticeably dark brown color. The previously-described 0.3% aqueous solution of chitosan having 0.01% sodium sulfite and 0.1% acetic acid inhibits discoloration of beef, thus prolonging both shelf-life and marketability.

### Example 5

Whole strawberries and sliced strawberries were immersed in the previously-described 0.3% aqueous solution of chitosan formed as described above having 0.01% sodium sulfite and 0.1% acetic acid. Untreated strawberries were used for comparison. The strawberries were maintained at room temperature for 3 days and then observed for appearance. Control whole strawberries were clearly discolored, while the whole strawberries treated with the chitosan solution were not discolored. Results of the shelf-life of the strawberries treated with chitosan (by an emersion technique) held at room temperature (abusive temperature and refrigeration) showed that control room temperature strawberries were moldy and had rot growth, while the chitosan-treated strawberries were not discolored and exhibited very little brown spots and no mold or rot growth. Similarly, control sliced strawberries were clearly discolored, while the sliced strawberries treated with the chitosan solution were not discolored. Results showed that the chitosan-treated cut strawberries exhibited no visible mold or rot growth compared to the control cut strawberries, which showed extensive mold and rot growth. After four days post treatment, no visible mold was observed on the chitosan-treated samples. The previously-described 0.3% aqueous solution of chitosan having 0.01% sodium sulfite and 0.1% acetic acid inhibits discoloration and mold growth of strawberries which dramatically increases shelf-life and marketability.

### Example 6

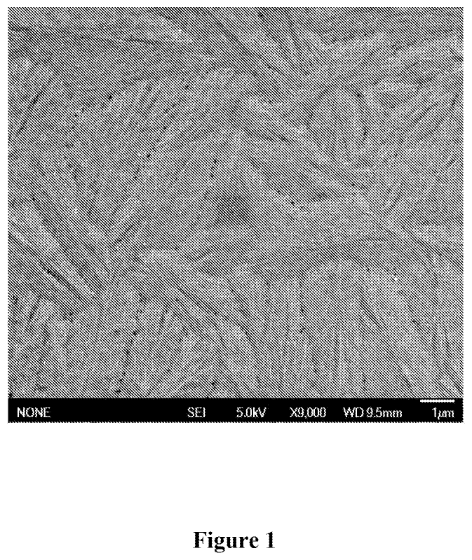

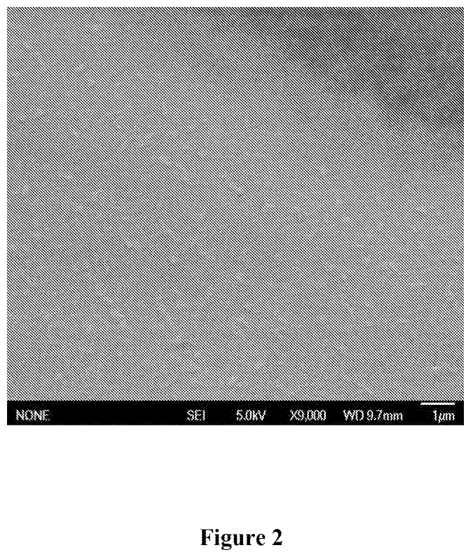

The previously-described 0.3% aqueous solution of chitosan formed as described above having 0.01% sodium sulfite and 0.1% acetic acid was applied to the surface of silicon wafers and allowed to dry at room temperature. The surface of the silicon wafers was then examined with scanning electron microscopy. In one sample, the chitosan solution was applied by placing a drop of the previously-described chitosan solution on the surface of the wafer and allowing it to dry, and in another sample the chitosan solution was applied by steam. Photographs of the scanning electron microscope images are shown in FIGS. 1 and 2. Both methods of applying the chitosan solution to the surface of the wafer produce a film or coating. These methods, and others disclosed herein, can likewise be applied to food. FIG. 1 shows chitosan coatings formed on silicon wafers when chitosan solutions of the present example were applied by placing a drop of chitosan solution on the surface of the wafer. FIG. 2 shows chitosan coatings formed by placing the chitosan by steam. The photograph was obtained by scanning electron microscopy of chitosan coatings formed on silicon wafers when chitosan solutions of the example were applied by a dry steam generator using the chitosan solution of the example as the liquid source. Application by steam produces a smoother, more uniform, coating than the coating formed by placing a drop of the previously-described chitosan, acetic acid, and sulfite salt solution on the surface of the wafer, while both methods clearly indicate film formation.

### Example 7

Non-frozen, refrigerated catfish fillets were purchased from a local grocery store and aseptically cubed into 25 g samples. The cubes were then separated and subjected to different treatment applications of the chitosan composition solution of the example: control (CT), chitosan steam (ST), chitosan dipping (DP), and chitosan electrostatic spray (ES). Samples were tested in triplicate intermittently on days 0, 2, 5, and 8 and were stored at about 4° C. Samples were plated on APC Petri film to determine total plate count and incubated at 37° C. for 24 hours.

Initial microflora for all samples, including the control, had average counts of 4.87 log CFU/g. By day 2, all samples excluding the dip-treated cubes had an increased microbial growth. Microbial counts for all samples increased by the final day. On day 8, both the dip-treated and electrostatic spray-treated samples had lower growth compared to the control with 6.19 log CFU/g, 7.03 log CFU/g, and 8.04 log CFU/g, respectively. The steam treatment was ineffective in controlling growth and was similar to the control. Both the dipping and electrostatic spray method for applying chitosan of the example proved to be suitable mechanisms to extend the shelf life of refrigerated catfish.

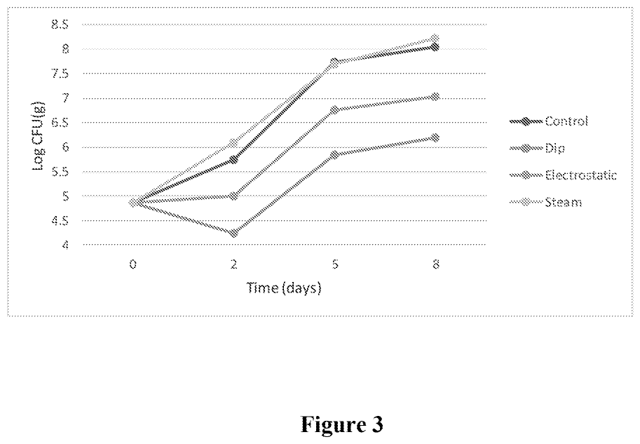

FIG. 3 shows the effect of treatment and application of the composition and method of the chitosan application of the example on concentration (Log CFU/g) over time of spoilage microorganisms in fresh catfish samples. Specifically, it shows the effect of the chitosan application of the example on shelf-life extension of refrigerated catfish stored at about 4° C. The graph in FIG. 3 shows the reduction of microbial counts vs. time for treated vs. untreated catfish, which extends both the saleable shelf-life and the appearance of such a product treated with the compositions of the example. Table 4 is a tabular form of the resultant data of FIG. 2 on days 0, 2, 5, and 8, respectively, for each treatment method.

TABLE 4

| Treatment | Day 0 | Day 2 | Day 5 | Day 8 |
|---|---|---|---|---|
| Control | 4.87 | 5.74 | 7.73 | 8.04 |
| Dip | 4.87 | 4.24 | 5.85 | 6.19 |
| Electrostatic | 4.87 | 5.01 | 6.77 | 7.03 |
| Steam | 4.87 | 6.09 | 7.7 | 8.23 |

The examples provide noticeable inhibition of discoloration on beef steak, whole strawberries, and sliced strawberries, for example, when treated with the chitosan solution of the present example. The example also provides for the inhibition and/or elimination of mold, particularly on berries, fruit, and vegetables. Moreover, the compositions of the example dramatically increase the shelf life of food. The example provides enhanced food preservation, food appearance, and increased shelf life. It further provides novel methods of preserving food by the application of an antimicrobial coating composed of aqueous chitosan solution compositions to food by steam, steaming, deposition from steam, dipping, spraying, electrostatic spraying, immersing, immersion, wiping, fogging, or a combination thereof. The methods of the example inhibit discoloration of food and microbial growth on and spoilage of food, and increase shelf life, or a combination thereof, as the results of the examples demonstrate.

All parameters presented herein including, but not limited to, sizes, dimensions, times, temperatures, pressures, amounts, quantities, ratios, weights, volumes, and/or percentages, and the like, for example, represent approximate values, i.e., “about”, unless specified otherwise, and can vary with the possible embodiments described and those not necessarily described but encompassed by the example. For example, a description of chitosan solution of the example being 5 to 7% chitosan by weight in water, preferably 6%, means about 5 to 7% chitosan, preferably about 6%, by weight in water. Unless defined otherwise, all technical and scientific terms used herein have the same meaning as commonly understood to one of ordinary skill in the art to which this disclosure belongs. Further, references to the singular forms “a”, “an”, and “the” concerning any particular item, component, material, or product include plural references and are defined as at least one and could be more than one, unless the context clearly dictates otherwise. The terminology employed is for the purpose of describing particular embodiments and is not intended to be limiting in any way.

The above detailed description is presented to enable any person skilled in the art to make and use the example. Specific details have been revealed to provide a comprehensive understanding of the present example and are used for explanation of the information provided. These specific details, however, are not required to practice the example, as is apparent to one skilled in the art. Descriptions of specific applications, examples, details, analyses, materials, components, dimensions, and calculations are meant to serve only as representative examples. Various modifications to the preferred embodiments may be readily apparent to one skilled in the art, and the general principles defined herein may be applicable to other embodiments and applications while still remaining within the scope of the disclosure. Moreover, some features of the disclosure may be employed without a corresponding use of the other features. There is no intention for the present disclosure to be limited to the embodiments shown and the disclosure is to be accorded the widest possible scope consistent with the principles and features disclosed herein.

While various embodiments of the present disclosure have been described above, it should be understood that they have been presented by way of example and not limitation. It will be apparent to persons skilled in the relevant art(s) that various changes in form and detail can be made therein without departing from the spirit and scope of the present disclosure. In fact, after reading the above description, it will be apparent to one skilled in the relevant art(s) how to implement the examples in alternative embodiments. The preferred embodiments of the disclosure have been described herein, but it should be understood that the broadest scope of the disclosure includes such modifications as additional or different methods and materials. Many other advantages of the examples will be apparent to those skilled in the art from the above descriptions and the subsequent preferred embodiments and/or claims. Thus, the present disclosure should not be limited by any of the above-described exemplary embodiments. The compositions, coatings, products, and methods of the present disclosure are often best practiced by empirically determining the appropriate values of the operating parameters, or by conducting simulations to arrive at best design for a given application. Accordingly, all suitable modifications, combinations, and equivalents should be considered as falling within the spirit and scope of the disclosure.

What is claimed is:

1. A method comprising:
obtaining a chitosan solution, the chitosan solution comprising an aqueous solution of deacetylated chitosan, a low molecular weight organic acid, and a soluble sulfite salt, wherein the aqueous solution is about 0.05% to 2.0% chitosan by weight in water, and wherein the chitosan comprises about 60% to 99% low molecular weight chitosan by weight, about 1% to 25% medium molecular weight chitosan by weight, and about 1% to 20% high molecular weight chitosan by weight; and
applying the chitosan solution to food.

2. The method of claim 1, wherein the chitosan solution is applied to the food by dipping the food in the chitosan solution.

3. The method of claim 1, wherein the chitosan solution is applied treating the food with chitosan steam.

4. The method of claim 1, wherein the chitosan solution is applied by treating the food with a chitosan electrostatic spray.

5. The method of claim 1, wherein the chitosan solution is applied to the food by spraying, immersion, wiping, fogging, or a combination thereof.

6. The method of claim 1, further comprising forming a protective chitosan solution film on the food.

7. The method of claim 6, wherein the film inhibits food discoloration.

8. The method of claim 6, wherein the film inhibits mold growth.

9. The method of claim 6, wherein the film inhibits food spoilage.

10. The method of claim 1, wherein the aqueous solution is edible.

11. The method of claim 1, wherein the sulfite salt in the aqueous solution is about 0.00025% to 0.25% by weight, and wherein the organic acid in the aqueous solution is about 0.0025% to 0.25% by weight.

12. The method of claim 1, wherein the sulfite salt in the aqueous solution is about 0.01% by weight, and wherein the organic acid in the aqueous solution is about 0.1% by weight.

13. The method of claim 1, wherein the organic acid is acetic acid, lactic acid, citric acid, or a combination thereof.

14. The method of claim 1, wherein the sulfite salt is potassium sulfite salt, ammonium sulfite salt, or a combination thereof.

15. A method comprising:
obtaining a chitosan solution, the chitosan solution comprising an aqueous solution of deacetylated chitosan, a low molecular weight organic acid, and a soluble sulfite salt, wherein the aqueous solution is about 0.05% to 2.0% chitosan by weight in water and wherein the low molecular weight chitosan is about 90% by weight, the medium molecular weight chitosan is about 5% by weight, and the high molecular weight chitosan is about 10% by weight; and
applying the chitosan solution to food.

16. The method of claim 15, wherein the chitosan solution is applied to the food by dipping, steaming, spraying, immersion, wiping, fogging, or a combination thereof.

17. The method of claim 15, further comprising forming a protective chitosan solution film on the food.

18. The method of claim 17, wherein the film inhibits food discoloration, mold growth, food spoilage, or combinations thereof.

19. The method of claim 14, wherein the aqueous solution is edible.

20. The method of claim 14, wherein the sulfite salt in the aqueous solution is about 0.01% by weight, and wherein the organic acid in the aqueous solution is about 0.1% by weight.
